(19) United States
(12) Patent Application Publication
(10) Pub. No.: US 2025/0372019 A1
(43) Pub. Date: Dec. 4, 2025

(54) METHOD FOR CONTEXT-AWARE DISPLAY CONTROL WITH SELECTIVE PIXEL ILLUMINATION

(71) Applicant: Volvo Car Corporation, Göteborg (SE)

(72) Inventors: Per Tengstrand, Göteborg (SE); Mehmet Mehmetalioglu, Göteborg (SE); Jessica Zanatta, Göteborg (SE); Manu Revi, Göteborg (SE)

(73) Assignee: Volvo Car Corporation, Göteborg (SE)

(21) Appl. No.: 18/679,571

(22) Filed: May 31, 2024

(51) Int. Cl. G09G 3/20; G06F 40/20; G09G 3/32

(52) U.S. Cl. CPC G09G 3/2085; G06F 40/20; G09G 3/32; G09G 2330/021; G09G 2354/00; G09G 2358/00; G09G 2380/10

(57) ABSTRACT

A system is described. The system comprises: a display; a display control module; and a processor storing instructions that, when executed, causes the processor to: analyze one or more contents and determine one or more contexts of the one or more contents; determine one or more redundant portions and one or more relevant portions of the one or more contents based on the contexts of the one or more contents; identify one or more first pixels that correspond to the one or more redundant portions; identify one or more second pixels that correspond to the one or more relevant portions; and communicate a command to the display control module to control the one or more first pixels and the one or more second pixels to display the one or more contents with optimized energy consumption in response to the contexts.

### FIELD OF THE INVENTION

The present disclosure relates generally to contextually responsive display. More specifically, the present disclosure relates to a system that analyzes contents and turns on only necessary pixels for minimizing energy consumption.

### BACKGROUND

Today, the majority of displays in vehicles use the LCD (Liquid Crystal Display) technology. On standard LCD monitors, all of the pixels in the entire picture are lit evenly throughout. This means that the display uses about the same amount of energy, regardless of whether it is showing a bright or dark image. Because all pixels have the same amount of backlight it is also hard to achieve a high level of contrast between light and dark areas of an image. Furthermore, an LCD display is produced using multiple layers that are bonded together, making it difficult to disassemble and recycle.

Further, a current trend amongst OEMs is to use one or more large displays to provide information and interactions to the driver and front seat passenger. These arrays of displays consume a lot of energy and can be distracting to the driver due to the large amount of information that is constantly displayed. The placement and orientation of the front row display(s) limits their use to the driver and front row passenger, thus excluding use by rear seat passengers or even use cases for viewing it outside of the vehicle.

Therefore, there is a long-felt need for a system and method for analyzing contents and turning on only necessary pixels for minimizing energy consumption.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In one or more embodiments described herein, systems, devices, computer-implemented methods, methods, apparatus and/or computer program products are presented that facilitate analyzing contents and turning on only necessary pixels for minimized energy consumption.

In an aspect, a system is described. The system comprises: a display; a display control module; and a processor storing instructions that, when executed, causes the processor to: analyze one or more contents and determine one or more contexts of the one or more contents; determine one or more redundant portions and one or more relevant portions of the one or more contents based on the one or more contexts of the one or more contents; identify one or more first pixels in the display that correspond to the one or more redundant portions of the one or more contents; identify one or more second pixels in the display that corresponds to the one or more relevant portions of the one or more contents; and communicate a command to the display control module to control the one or more first pixels and the one or more second pixels to display the one or more contents with optimized energy consumption in response to the one or more contexts.

In another aspect, a system is described. The system comprises: a display; a sensor module; a display alignment and orientation module; and a processor storing instructions that, when executed, causes the processor to: determine position of one or more occupants based on a first signal received from the sensor module; determine a movement of a vehicle based on a second signal received from the sensor module; determine an operating mode of the vehicle based on the position of the one or more occupants and the movement of the vehicle; and communicate a command to the display alignment and orientation module to automatically align and orient the display with respect to the one or more occupants and activate one or more portions of the display based on the operating mode of the vehicle.

In another aspect, a method is described. The method comprises: analyzing one or more contents and determining one or more contexts of the one or more contents; determining one or more redundant portions and one or more relevant portions of the one or more contents based on the one or more contexts of the one or more contents; identifying one or more first pixels in the display that correspond to the one or more redundant portions of the one or more contents; identifying one or more second pixels in the display that corresponds to the one or more relevant portions of the one or more contents; and communicating a command to a display control module to control the one or more first pixels and the one or more second pixels to display the one or more contents with optimized energy consumption in response to the one or more contexts.

In another aspect, a method is described. The method comprises: determining position of one or more occupants based on a first signal received from a sensor module; determining a movement of a vehicle based on a second signal received from the sensor module; determining an operating mode of the vehicle based on the position of the one or more occupants and the movement of the vehicle; and communicating a command to a display alignment and orientation module to automatically align and orient a display with respect to the one or more occupants and activate one or more portions of the display based on the operating mode of the vehicle.

In another aspect, a non-transitory computer readable medium is described. The non-transitory computer readable medium storing a sequence of instructions, which when executed by a processor causes: analyzing one or more contents and determining one or more contexts of the one or more contents; determining one or more redundant portions and one or more relevant portions of the one or more contents based on the one or more contexts of the one or more contents; identifying one or more first pixels in the display that correspond to the one or more redundant portions of the one or more contents; identifying one or more second pixels in the display that corresponds to the one or more relevant portions of the one or more contents; and communicating a command to a display control module to control the one or more first pixels and the one or more second pixels to display the one or more contents with optimized energy consumption in response to the one or more contexts.

In another aspect, a non-transitory computer readable medium is described. The non-transitory computer readable medium storing a sequence of instructions, which when executed by a processor causes: determining position of one or more occupants based on a first signal received from a sensor module; determining a movement of a vehicle based on a second signal received from the sensor module; determining an operating mode of the vehicle based on the position of the one or more occupants and the movement of the vehicle; and communicating a command to a display alignment and orientation module to automatically align and orient a display with respect to the one or more occupants and activate one or more portions of the display based on the operating mode of the vehicle.

The methods and systems disclosed herein may be implemented in any means for achieving various aspects and may be executed in a form of a non-transitory machine-readable medium embodying a set of instructions that, when executed by a machine, causes the machine to perform any of the operations disclosed herein. Other features will be apparent from the accompanying drawings and from the detailed description that follows.

### BRIEF DESCRIPTION OF THE FIGURES

These and other aspects of the present disclosure will now be described in more detail, with reference to the appended drawings showing exemplary embodiments, in which:

FIG. 1 illustrates a system that facilitates analyzing one or more contents and turning on only necessary pixels for optimized energy consumption, according to one or more embodiments.

FIG. 2 illustrates a system that aligns, and orients the display for optimized energy consumption, according to one or more embodiments.

FIG. 3 illustrates a method of analyzing one or more contents and turning on only necessary pixels for optimized energy consumption, according to one or more embodiments.

FIG. 4 illustrates a method of aligning and orienting the display for optimized energy consumption, according to one or more embodiments.

FIG. 5 illustrates a non-transitory computer readable medium, according to one or more embodiments.

FIG. 6 illustrates a non-transitory computer readable medium, according to one or more embodiments.

FIG. 7 illustrates a schematic diagram of a micro-LED display, according to one or more embodiments.

FIG. 8 illustrates a schematic diagram of a micro-LED display depicting one or more relevant pixels and one or more redundant pixels, according to one or more embodiments.

FIG. 9 illustrates a command communicated to a display control module, according to one or more embodiments.

FIG. 10 illustrates a command communicated to a display alignment and orientation module, according to one or more embodiments.

FIG. 11 illustrates a display control module turning off a single pixel of a display, according to one or more embodiments.

FIG. 12 illustrates a display in a waiting mode, according to one or more embodiments.

FIG. 13 illustrates a display in a driving mode, according to one or more embodiments.

FIG. 14 illustrates a display in a campfire mode, according to one or more embodiments.

FIG. 15A shows a block diagram of the cyber security module in view of the system and server.

FIG. 15B shows an embodiment of the cyber security module.

FIG. 15C shows another embodiment of the cyber security module.

FIG. 16A shows a structure of the neural network/machine learning model with a feedback loop.

FIG. 16B shows a structure of the neural network/machine learning model with reinforcement learning.

Other features of the present embodiments will be apparent from the accompanying drawings and from the detailed description that follows.

### DETAILED DESCRIPTION

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs.

Unless defined otherwise, all technical and scientific terms used herein have the same meaning as commonly understood by one with ordinary skill in the art.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more”. Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc., in question is or is not removable.

As used herein, the term “or” means an inclusive “or” rather than an exclusive “or.” That is, unless specified otherwise, or clear from context. “X employs A or B” means any of the natural inclusive permutations. That is, if X employs A; X employs B; or X employs both A and B, then “X employs A or B” is satisfied under any of the foregoing instances.

As used herein, two or more elements or modules are “integral” or “integrated” if they operate functionally together. Two or more elements are “non-integral” if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Digital electronic circuitry, or in computer software, firmware, or hardware, including the structures disclosed in this specification and their structural equivalents, or in combinations of one or more of them may realize the implementations and all of the functional operations described in this specification. Implementations may be as one or more computer program products, i.e., one or more modules of computer program instructions encoded on a computer-readable medium for execution by, or to control the operation of, data processing apparatus. The computer-readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of a digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc., may embed a computer. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship to each other.

Embodiments may comprise or utilize a special purpose or general purpose computer including computer hardware. Embodiments within the scope of the present invention may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments of the invention can comprise at least two distinct kinds of computer-readable media: physical computer-readable storage media and transmission computer-readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer-readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer-readable media includes combinations of the above, that enable the transport of electronic data between computer systems and/or modules and/or other electronic devices. Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a Network Interface Module (NIC), and then eventually transferred to computer system RAM and/or to less volatile computer-readable physical storage media at a computer system. Thus, computer system components that also (or even primarily) utilize transmission media may include computer-readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

Those skilled in the art will appreciate that the invention may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the invention. In a distributed system environment, program modules may be located in both local and remote memory storage devices.

The following terms and phrases, unless otherwise indicated, shall have the following meanings.

As used herein, the term “sensor module” refers to a unit that contains components or circuits in addition to the sensors. The additional components or circuits make the sensor easy to use. The sensor module may be an integrated circuit comprising additional components and sensors adaptable for an application. The sensor module may comprise one or more sensors that operate functionally together. For example, the one or more cameras and the one or more sensors within the sensor module are integrated with one another to determine interior features and exterior features. The sensors within the sensor module may operate in an integrated manner to monitor the environmental conditions, external surroundings, ambient lighting, occupants within the vehicle, etc.

As used herein, the term “display control module” refers to a unit or a system that controls the luminance of the display based on the command received from the processor. The term “display control module” means a component designed to operate the combined functioning of all display components of the vehicle.

As used herein, the term “electric vehicle (EV)” refers to an automobile, as defined in 49 CFR 523.3, intended for highway use, powered by an electric motor that draws current from an on-vehicle energy storage device, such as a battery, which is rechargeable from an off-vehicle source, such as residential or public electric service or an on-vehicle fuel powered generator. The EV may be two or more wheeled vehicles manufactured for use primarily on public streets, roads. The EV may be referred to as an electric car, an electric automobile, an electric road vehicle (ERV), a plug-in vehicle (PV), a plug-in vehicle (xEV), etc., and the xEV may be classified into a plug-in all-electric vehicle (BEV), a battery electric vehicle, a plug-in electric vehicle (PEV), a hybrid electric vehicle (HEV), a hybrid plug-in electric vehicle (HPEV), a plug-in hybrid electric vehicle (PHEV), etc.

As used herein, the term “plug-in electric vehicle (PEV)” refers to an Electric Vehicle that recharges the on-vehicle primary battery by connecting to the power grid.

As used herein, the term “plug-in vehicle (PV)” refers to an electric vehicle rechargeable through wireless charging from an electric vehicle supply equipment (EVSE) without using a physical plug or a physical socket.

As used herein, the term “heavy duty vehicle (HD Vehicle)” refers to any four-or more wheeled vehicle as defined in 49 CFR 523.6 or 49 CFR 37.3 (bus).

As used herein, the term “light duty plug-in electric vehicle” refers to a three or four-wheeled vehicle propelled by an electric motor drawing current from a rechargeable storage battery or other energy devices for use primarily on public streets, roads and highways and rated at less than 4, 545 kg gross vehicle weight.

As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

As used herein, the term “vehicle computer system” refers to an embedded system in automotive electronics that controls one or more of the electrical systems or subsystems in a vehicle. The computer executes a large number of different software functions in the powertrain, chassis, driver assistance, and infotainment domains, etc., that are executed on separate control units. The vehicle computer system may be communicatively coupled with an external device of a user.

As used herein, the term “infotainment system” or “infotainment unit” or “in-vehicle infotainment system” (IVI) as used herein refers to a combination of systems which are used to deliver entertainment and information. In an example, the information may be delivered to the driver and the passengers of a vehicle through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

As used herein, the term “machine learning” refers to algorithms that give a computer the ability to learn without being explicitly programmed, including algorithms that learn from and make predictions about data. Machine learning algorithms include, but are not limited to, decision tree learning, artificial neural networks (ANN) (also referred to herein as a “neural net”), deep learning neural network, support vector machines, rules-based machine learning, random forest, etc. For the purposes of clarity, algorithms such as linear regression or logistic regression can also be used as part of a machine learning process. However, it is understood that using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. Statistical modelling relies on finding relationships between variables (e.g., mathematical equations) to predict an outcome. The ANN may be featured with a feedback loop to adjust the system output dynamically as it learns from the new data as it becomes available. In machine learning, backpropagation and feedback loops are used to train the AI/ML model improving the model's accuracy and performance over time.

As used herein, the term “communication” refers to the transmission of information and/or data from one point to another. Communication may be by means of electromagnetic waves. It is also a flow of information from one point, known as the source, to another, the receiver. Communication comprises one of the following: transmitting data, instructions, and information or a combination of data, instructions, and information. Communication happens between any two communication systems or communicating units. The term “in communication with” may refer to any coupling, connection, or interaction using electrical signals to exchange information or data, using any system, hardware, software, protocol, or format, regardless of whether the exchange occurs wirelessly or over a wired connection. The term “communication” includes systems that combine other more specific types of communication, such as V2I (Vehicle-to-Infrastructure), V2I (Vehicle-to-Infrastructure), V2N (Vehicle-to-Network), V2V (Vehicle-to-Vehicle), V2P (Vehicle-to-Pedestrian), V2D (Vehicle-to-Device) and V2G (Vehicle-to-Grid) and Vehicle-to-Everything (V2X) communication. V2X communication is the transmission of information from a vehicle to any entity that may affect the vehicle, and vice versa. The main motivations for developing V2X are occupant safety, road safety, traffic efficiency and energy efficiency. Depending on the underlying technology employed, there are two types of V2X communication technologies: cellular networks and other technologies that support direct device-to-device communication (such as Dedicated Short-Range Communication (DSRC), Port Community System (PCS), Bluetooth® Wi-Fi®, etc.). Further, the emergency communication apparatus is configured on a computer with the communication function and is connected for bidirectional communication with the on-vehicle emergency report apparatus by a communication line through a radio station and a communication network such as a public telephone network or by satellite communication through a communication satellite. The emergency communication apparatus is adapted to communicate, through the communication network, with communication terminals including a road management office, a police station, a fire department, and a hospital. The emergency communication apparatus can also be connected online with the communication terminals of the persons or vehicles concerned, associated with the occupant or vehicle, and the driver or vehicle receiving the service, of the emergency-reporting vehicle.

As used herein, the term “message structure” refers to a structure of a communication message when a query and fetch operation occurs. It comprises a payload and a header, where the payload includes the quantitative value of the information that is shared, and the header includes reference to the information being shared. The message structure acts as a superstructure to accommodate any sub protocol structure such as AMQP, MQTT, Zigbee, etc.

As used herein, the term “artificial intelligence engine” refers to any system that perceives its environment and takes actions that maximize its chance of achieving its goals. An artificial intelligence unit utilizes a plurality of machine learning algorithms that allow systems to automatically improve through experience.

As used herein, the term “communication system” or “communication module” as used herein refers to a system which enables the information exchange between two points. The process of transmission and reception of information is called communication. The major elements of communication include but are not limited to a transmitter of information, channel or medium of communication and a receiver of information.

As used herein, the term “artificial intelligence (AI)” refers to the intelligence demonstrated by machines, as opposed to the natural intelligence displayed by humans. AI research has been defined as any system that perceives its environment and takes actions that maximize its chance of achieving its goals. The term “artificial intelligence” is now described in terms of rationality and acting rationally, which does not limit how intelligence can be articulated.

As used herein, the term “operating mode” refers to a mode of operation of the vehicle. The vehicle operating mode may comprise one of an auto pilot mode, an autonomous mode, a non-autonomous mode, and a semi-autonomous mode. The operating mode may also comprise one of a driving mode, a standby mode, a parking mode, a campfire mode, etc.

As used herein, the term “occupant” refers to a person seated in the vehicle. The occupant is one of a child, a kid, an adult, and an aged person. The occupant may be a driver, a passenger, etc. The occupant may exit from the vehicle. In the event of the occupant exiting from the vehicle, the vehicle may operate in auto-pilot mode.

As used herein, the term “content” refers to an object, a data, a visual representation, information, etc. The content may comprise meaningful (e.g., relevant) information. The content may also comprise random (e.g., redundant) information that is meaningless.

As used herein, the term “entity ID” may be a vehicle identification number. The vehicle identification number refers to an identifying code for a specific automobile. The vehicle identification number (VIN) is a unique code, including a serial number, used to identify individual motor vehicles.

As used herein, the term “coordinates” refers to a set of values that shows an exact position.

As used herein, the term “Unauthorized access” is when someone gains access to a website, program, server, service, or other system using someone else's account or other methods. For example, if someone kept guessing a password or username for an account that was not theirs until they gained access, it is considered unauthorized access.

As used herein “Machine learning” refers to algorithms that give a computer the ability to learn without being explicitly programmed, including algorithms that learn from and make predictions about data. Machine learning techniques include, but are not limited to, and support vector machine, artificial neural network (ANN) (also referred to herein as a “neural net”), deep learning neural network, logistic regression, discriminant analysis, random forest, linear regression, rules-based machine learning, Naive Bayes, nearest neighbor, decision tree, decision tree learning, and hidden Markov, etc. For the purposes of clarity, algorithms such as linear regression or logistic regression can also be used as part of a machine learning process. However, it is understood that using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. The ANN may be featured with a feedback loop to adjust the system output dynamically as it learns from the new data as it becomes available. In machine learning, backpropagation and feedback loops are used to train the AI/ML model improving the model's accuracy and performance over time.

As used herein, the term “Dashboard” is a type of interface that visualizes particular Key Performance Indicators (KPIs) for a specific goal or process. It is based on data visualization and infographics.

As used herein, the term “entity” refers to a unit or item or apparatus that exists and can be identified as a distinct unit. For example, the entity may be a vehicle, a train, etc.

As used herein, the term “context” refers to circumstances, background, and environment in which the content is created, distributed, and consumed. Understanding the context of content is essential for interpreting its meaning accurately. The context comprises at least one of a subject matter or key information of what the content is about. Context enables the readers (whether human or machine) to understand what the content is about.

As used herein, the term “redundant portions” refers to portions encompassing unnecessary repetition of information or ideas that do not add value or clarity. Redundant portions can make the content verbose and less engaging for the audience.

As used herein, the term “relevant portions” refers to portions that directly contribute to the main message, theme, or purpose of the piece. Relevant portions provide essential information, insights, or support for the central idea. Relevant portions may refer to specific segments or sections that directly address the needs, interests, or inquiries of the audience. Relevant portions are essential for maintaining the audience's engagement and providing them with valuable information or insights.

As used herein, the term “pixels” refers to picture elements. The pixels are the smallest controllable elements of a digital image. Pixels are the building blocks that make up digital images displayed on screens, such as computer monitors, smartphone displays, or television screens. Each pixel contains color and brightness information, which collectively form an image when viewed from a distance.

As used herein, the term “command” refers to instructions given to perform a specific function. The command may specify a particular operation such as performing arithmetic calculations, moving data between memory locations, branching to a different part of the program, or interacting with input/output devices. Commands are encoded in binary format and are represented by a sequence of bits that the appropriate module interprets and executes. The module fetches instructions and decodes them to determine the operation to perform, and then executes them accordingly.

As used herein, the term “optimized energy consumption” refers to the efficient use of energy resources to minimize waste and maximize performance or functionality.

As used herein, a “Database” is a collection of organized information so that it can be easily accessed, managed, and updated. Computer databases typically contain aggregations of data records or files.

As used herein, the term “interior features” refers to characteristics, elements, and components found inside entities (e.g., vehicles, or other enclosed spaces). Interior features contribute to the functionality, aesthetics, comfort, and usability of the interior environment. Interior features of a vehicle refer to the components, amenities, and design elements found inside the vehicle's cabin. Interior features contribute to at least one of comfort, convenience, safety, and overall driving experience for passengers and drivers. Interior features encompass seating, dashboard and instrumentation, steering wheel, audio and entertainment, safety and assistance, and interior lighting, etc.

As used herein, the term “exterior features” refers to characteristics, elements, and components found outside entities (e.g., display on a vehicle windshield, enclosed spaces, etc.). Exterior features encompass movement, location of entity, ambient lighting, etc.

As used herein, the term “Natural Language Processing” refers to a field of artificial intelligence (AI) that focuses on the interaction between computers and humans through natural language. NLP is used to enable computers to understand, interpret, and generate human language in a way that is both meaningful and useful.

As used herein, the term “operating mode” refers to a specific state or condition in which the vehicle is functioning at any given time. Different operating modes correspond to various driving scenarios, conditions, and requirements, and they can affect the vehicle's performance, efficiency, and behavior.

As used herein, the term “standby mode” refers to a state in which the vehicle's engine is not actively running but certain systems remain powered on for various functions. Standby mode can be activated when the vehicle is parked or stationary, and it serves to conserve fuel, reduce emissions, and provide functionality for auxiliary systems.

As used herein, the term “parking mode” refers to a state in which the vehicle is parked in a designated parking space or area, where it can be safely and legally left unattended for a period of time.

As used herein, the term “campfire mode” refers to a state in which the vehicle is utilized for amusement or entertainment purposes. The front row and back row of seats face each other enabling interaction between the occupants.

As used herein, the term “trigger signal” refers to a signal or event that initiates or activates a particular action, process, or response in a system or device.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

As used herein, a “Sensor” is a device that detects and measures physical properties from the surrounding environment and converts this information into electrical or digital signals that can be interpreted by either a human or a machine for further processing. Sensors play a crucial role in collecting data for various applications across industries. Sensors may be made of electronic, mechanical, chemical, or other engineering components. Most sensors are electronic (the data is converted into electronic data), but some are simpler, such as a glass thermometer, which presents visual data. Examples include sensors to measure temperature, pressure, humidity, proximity, light, acceleration, orientation etc. In an embodiment, sensors may be removably or fixedly installed within the vehicle and may be disposed in various arrangements to provide information to the autonomous operation features. The sensors may include one or more of a GPS unit, a radar unit, a LIDAR unit, an ultrasonic sensor, an infrared sensor, an inductance sensor, a camera, an accelerometer, a tachometer, a tension sensor, or a speedometer. Some of the sensors (e.g., radar, LIDAR, or camera units) may actively or passively scan the interior of the vehicle for the presence of occupants (e.g., child, adult, kids, passenger, driver, etc.) to determine occupant weight and vehicle weight.

The term “vehicle” as used herein refers to a thing used for transporting people or goods. Automobiles, cars, trucks, buses, etc., are examples of vehicles.

The terms “non-transitory computer-readable medium” and “computer-readable medium” include a single medium or multiple media such as a centralized or distributed database, and/or associated caches and servers that store one or more sets of instructions. Further, the terms “non-transitory computer-readable medium” and “computer-readable medium” include any tangible medium that is capable of storing, encoding, or carrying a set of instructions for execution by a processor that, for example, when executed, cause a system to perform any one or more of the methods or operations disclosed herein. As used herein, the term “computer readable medium” is expressly defined to include any type of computer readable storage device and/or storage disk and

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in an RS-232 serial transmission. A software handshake sends codes such as “synchronize” (SYN) and “acknowledge” (ACK) in a TCP/IP transmission.

The term “infotainment system” or “in-vehicle infotainment system” (IVI) as used herein refers to a combination of vehicle systems which are used to deliver entertainment and information. In an example, the information may be delivered to the driver and the passengers of a vehicle/occupants through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

The term “autonomous mode” as used herein refers to a vehicle operating mode which is independent and unsupervised.

The term “autonomous communication” as used herein comprises communication over a period with minimal supervision under different scenarios and is not solely or completely based on pre-coded scenarios or pre-coded rules or a predefined protocol. Autonomous communication, in general, happens in an independent and an unsupervised manner. In an embodiment, a communication module is enabled for autonomous communication.

The term “communication protocol” as used herein refers to standardized communication between any two systems. An example of a communication protocol is the DSRC protocol. The DSRC protocol uses a specific frequency band (e.g., 5.9 GHZ) and specific message formats (such as the Basic Safety Message, Signal Phase and Timing, and Roadside Alert) to enable communications between vehicles and infrastructure components, such as traffic signals and roadside sensors. DSRC is a standardized protocol, and its specifications are maintained by various organizations, including the IEEE and SAE International.

The term “cyber security” as used herein refers to application of technologies, processes, and controls to protect systems, networks, programs, devices, and data from cyber-attacks.

The term “cyber security module” as used herein refers to a module comprising application of technologies, processes, and controls to protect systems, networks, programs, devices and data from cyber-attacks and threats. It aims to reduce the risk of cyber-attacks and protect against the unauthorized exploitation of systems, networks, and technologies. It includes, but is not limited to, critical infrastructure security, application security, network security, cloud security, Internet of Things (IoT) security.

The term “encrypt” used herein refers to securing digital data using one or more mathematical techniques, along with a password or “key” used to decrypt the information. It refers to converting information or data into a code, especially to prevent unauthorized access. It may also refer to concealing information or data by converting it into a code. It may also be referred to as cipher, code, encipher, encode. A simple example is representing alphabets with numbers-say, ‘A’ is ‘01’, ‘B’ is ‘02’, and so on. For example, a message like “HELLO” will be encrypted as “0805121215,” and this value will be transmitted over the network to the destination or recipient(s).

The term “decrypt” used herein refers to the process of converting an encrypted message back to its original format. It is generally a reverse process of encryption. It decodes the encrypted information so that only an authorized user can decrypt the data because decryption requires a secret key or password. This term could be used to describe a method of unencrypting the data manually or unencrypting the data using the proper codes or keys.

The term “cyber security threat” used herein refers to any possible malicious attack that seeks to unlawfully access data, disrupt digital operations, or damage information. A malicious act includes but is not limited to damaging data, stealing data, or disrupting digital life in general. Cyber threats include, but are not limited to, malware, spyware, phishing attacks, ransomware, zero-day exploits, trojans, advanced persistent threats, wiper attacks, data manipulation, data destruction, rogue software, malvertising, unpatched software, computer viruses, man-in-the-middle attacks, data breaches, Denial of Service (DOS) attacks, and other attack vectors.

The term “hash value” used herein can be thought of as fingerprints for files. The contents of a file are processed through a cryptographic algorithm, and a unique numerical value, the hash value, is produced that identifies the contents of the file. If the contents are modified in any way, the value of the hash will also change significantly. Example algorithms used to produce hash values: the Message Digest-5 (MD5) algorithm and Secure Hash Algorithm-1 (SHA1).

The term “integrity check” as used herein refers to the checking for accuracy and consistency of system related files, data, etc. It may be performed using checking tools that can detect whether any critical system files have been changed, thus enabling the system administrator to look for unauthorized alteration of the system. For example, data integrity corresponds to the quality of data in the databases and to the level by which users examine data quality, integrity, and reliability. Data integrity checks verify that the data in the database is accurate, and functions as expected within a given application.

The term “alarm” as used herein refers to a trigger when a component in a system or the system fails or does not perform as expected. The system may enter an alarm state when a certain event occurs. An alarm indication signal is a visual signal to indicate the alarm state. For example, when a cyber security threat is detected, a system administrator may be alerted via sound alarm, a message, a glowing LED, a pop-up window, etc. Alarm indication signal may be reported downstream from a detecting device, to prevent adverse situations or cascading effects.

The term “in communication with” as used herein, refers to any coupling, connection, or interaction using electrical signals to exchange information or data, using any system, hardware, software, protocol, or format, regardless of whether the exchange occurs wirelessly or over a wired connection.

As used herein, the term “cryptographic protocol” is also known as security protocol or encryption protocol. It is an abstract or concrete protocol that performs a security-related function and applies cryptographic methods often as sequences of cryptographic primitives. A protocol describes how the algorithms should be used. A sufficiently detailed protocol includes details about data structures and representations, at which point it can be used to implement multiple, interoperable versions of a program. Cryptographic protocols are widely used for secure application-level data transport. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation. Hashing algorithms may be used to verify the integrity of data. Secure Socket Layer (SSL) and Transport Layer Security (TLS), the successor to SSL, are cryptographic protocols that may be used by networking switches to secure data communications over a network.

As used herein, the term “network” may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

The term “autonomous vehicle” also referred to as self-driving vehicle, driverless vehicle, robotic vehicle as used herein refers to a vehicle incorporating vehicular automation, that is, a ground vehicle that can sense its environment and move safely with little or no human input. Self-driving vehicles combine a variety of sensors to perceive their surroundings, such as thermographic cameras, Radio Detection and Ranging (radar), Light Detection and Ranging (lidar), Sound Navigation and Ranging (sonar), Global Positioning System (GPS), odometry and inertial measurement unit. Control systems, designed for the purpose, interpret sensor information to identify appropriate navigation paths, as well as obstacles and relevant signage.

As used herein, the term “semi-autonomous vehicle” refers to vehicles that can operate for extended periods with little human input. A semi-autonomous vehicle cannot drive itself at all times, but does automate some driving functions under ideal conditions like highway driving. A semi-autonomous vehicle may use “autopilot” features. In one embodiment, semi-autonomous vehicles may be able to keep in lane, and they may also be able to park themselves, but they are not self-driving. The semi-autonomous vehicles act independently to some degree.

As used herein the term “connection” as used herein refers to a communication link. It refers to a communication channel that connects two or more devices for the purpose of data transmission. It may refer to a physical transmission medium such as a wire, or to a logical connection over a multiplexed medium such as a radio channel in telecommunications and computer networking. A channel is used for information transfer of, for example a digital bit stream, from one or several senders to one or several receivers. A channel has a certain capacity for transmitting information, often measured by its bandwidth in Hertz (Hz) or its data rate in bits per second. For example, a Vehicle-to-Vehicle (V2V) communication may wirelessly exchange information about the speed, location and heading of surrounding vehicles.

The term “protocol” as used herein refers to a procedure required to initiate and maintain communication; a formal set of conventions governing the format and relative timing of message exchange between two communications terminals; a set of conventions that govern the interaction of processes, devices, and other components within a system; a set of signaling rules used to convey information or commands between boards connected to the bus; a set of signaling rules used to convey information between agents; a set of semantic and syntactic rules that determine the behavior of entities that interact; a set of rules and formats (semantic and syntactic) that determines the communication behavior of simulation applications; a set of conventions or rules that govern the interactions of processes or applications within a computer system or network; a formal set of conventions governing the format and relative timing of message exchange in a computer system; a set of semantic and syntactic rules that determine the behavior of functional units in achieving meaningful communication; a set of semantic and syntactic rules for exchanging information.

As used herein, the term “component” broadly construes hardware, firmware, and/or a combination of hardware, firmware, and software.

The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. For example, the computer readable storage medium can be, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, does not construe transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein are downloadable to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA), and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter described herein is in the general context of computer-executable instructions of a computer program product that runs on a computer and/or computers, those skilled in the art will recognize that the one or more embodiments herein also can be implemented in combination with one or more other program modules. Program modules include routines, programs, components, data structures, and/or the like that perform particular tasks and/or implement particular abstract data types. Moreover, other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like can practice the herein described computer-implemented methods. Distributed computing environments, in which remote processing devices linked through a communications network perform tasks, can also practice the illustrated aspects. However, stand-alone computers can practice one or more, if not all, aspects of the one or more embodiments described herein. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

As it is employed in the subject specification, the term “processor” can refer to any computing processing unit and/or device comprising, but not limited to, single-core processors; single-processors with software multi-thread execution capability; multi-core processors; multi-core processors with software multi-thread execution capability; multi-core processors with hardware multi-thread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A combination of computing processing units can implement a processor.

Herein, terms such as “store,” “storage,” “data store,” data storage,” “database,” and any other information storage component relevant to operation and functionality of a component refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random access memory (RAM) (e.g., ferroelectric RAM (FeRAM). Volatile memory can include RAM, which can function as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein include, without being limited to including, these and/or any other suitable types of memory.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

Technical problem 1: Today, the majority of displays in vehicles use the LCD (Liquid Crystal Display) technology. On standard LCD monitors, all of the pixels in the entire picture are lit evenly throughout. This means that the display uses about the same amount of energy, regardless of whether it is showing a bright or dark image. Because all pixels have the same amount of backlight it is also hard to achieve a high level of contrast between light and dark areas of an image. Furthermore, an LCD display is produced using multiple layers that are bonded together, making it difficult to disassemble and recycle. Further, a current trend amongst OEMS is to use one or more large displays to provide information and interactions to the driver and front seat passenger. these arrays of displays consume a lot of energy and can be distracting to the driver due to the large amount of information that is constantly displayed. the placement and orientation of the front row display(s) limit their use to the driver and front row passenger, thus excluding use by rear seat passengers or even use cases for viewing it outside of the vehicle.

Technical Solution 1: The display uses the micro-LED technology. The micro-LED has many advantages over an LCD display, and even other LED display technologies, such as increased brightness, long lifespan, and low energy consumption. It also consists of a lot fewer materials compared to LCDs and other LED technologies and can easily be disassembled and repaired if individual pixels are damaged or faulty. The backlighting in a micro-LED display requires fewer bulbs, resulting in a more efficient energy usage. On top of that, LED displays also tend to last much longer than LCDs due to their higher efficiency rates and lower levels of heat production. LED displays also have the ability to dim a local region of an image to create a truer black. This is not possible on standard LCD monitors, where the entire picture is lit evenly throughout.

The micro-LED display is associated with the supporting structure to provide a seamless and unnoticeable transition between the display and its supporting structure. The display is primarily used to enable interactions with on-screen content during both driving and at standstill. Additionally, the size, position and orientation of the display allows it to be used to communicate with users outside the car when it is parked, both at a distance or as the user approaches the car. This can be to greet a known user or to invite a passerby to use the car and its capabilities on-demand.

The display uses signals from hardware triggers in the structure, interpreted through software, to determine what content is shown and how it can be interacted with. Hardware triggers can be, for example, the position of the steering wheel, the spatial orientation of passengers and their seats and other modular elements of the interior car cabin. In one embodiment, the hardware triggers may arise at any time (e.g., the vehicle is in motion, the vehicle is standing still (parked)) and be used at any time (e.g., the vehicle is in motion, the vehicle is standing still (parked)).

The display makes further use of the capabilities of a Micro-LED display. The graphics of the user interface (UI) shown on the display are developed to use the colors that consume the least amount of energy. For each mode of use (see illustration of FIGS. 12, 13, and 14 the display turns on only the pixels that are needed to show the UI at any given time (see illustration of FIG. 11). If the user opens a menu, the necessary pixels are turned on, but only for as long as the menu is in use. When the display software recognizes that a certain visual element is not needed or interacted with, it turns off the pixels used for that element to save energy. This way the display is constantly using software to analyze what pixels are in use and which ones can be turned off, thus minimizing the energy consumption further. The energy that the display automatically saves can be used to extend range or be shared with 3rd parties when parked.

The content on the display can be both generated from the car's on-board software, or generated from each user's digital eco system that connects to the car when interacting with it.

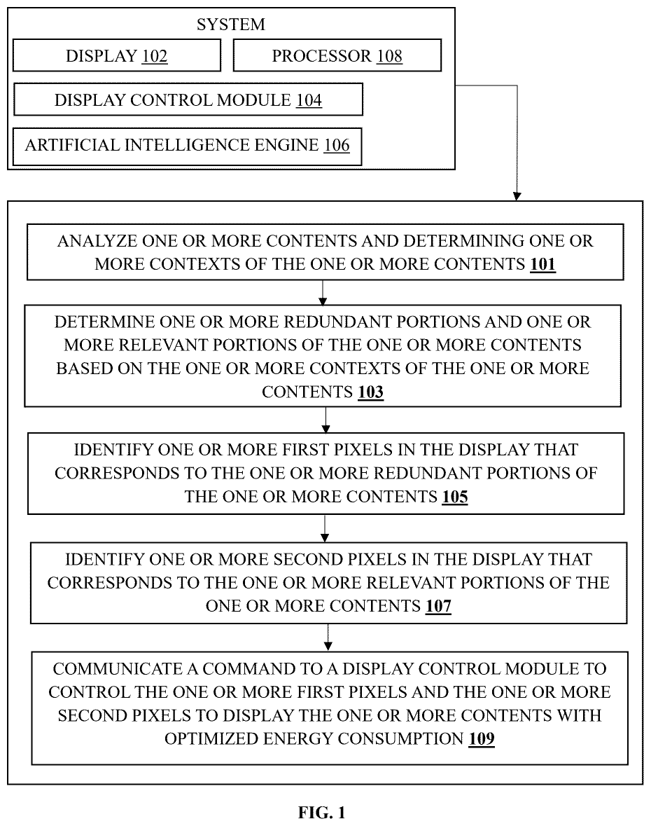

In an aspect, a system is described. As an example, FIG. 1 illustrates a system that facilitates analyzing one or more contents and turning on only necessary pixels for optimized energy consumption, according to one or more embodiments. The system comprises: a display 102; a display control module 104; and a processor 108. In one embodiment, the system comprises an artificial intelligence engine 106. The processor 108 stores instructions that, when executed, causes the processor 108 to execute the technical steps as follows. The processor 108 analyzes one or more contents and determines one or more contexts of the one or more contents (at step 101). The processor 108 determines one or more redundant portions and one or more relevant portions of the one or more contents based on the one or more contexts of the one or more contents (at step 103). The processor 108 identifies one or more first pixels in the display that correspond to the one or more redundant portions of the one or more contents (at step 105). The processor 108 identifies one or more second pixels in the display that corresponds to the one or more relevant portions of the one or more contents (at step 107). The processor 108 then communicates a command to the display control module to control the one or more first pixels and the one or more second pixels to display the one or more contents with optimized energy consumption (at step 109). The one or more contents may be one of an audio, a video, a text message, an image, a visual element, a graphics interchange format (gif) image, a report, a workstation document, a video game, etc. The one or more contents may also be structured data, unstructured data, semi-structured data, etc. The context refers to subject matter or core concept of the contents. The context refers to characteristics that provide a basis for understanding its scope of the contents. The context may also refer to characteristics that distinguishes one content from another content.

In an embodiment, the system further comprises a content receiving module that receives one or more contents from a source. The content receiving module may receive the one or more contents either through wired connection or wireless connection via a cyber security module. The system may comprise a cyber security module that minimizes counterfeit activities in transmitting and receiving contents. The source may be one of an external device, a vehicle computer system, or an infotainment unit. The external device may be one of a smartphone, a tablet, a personal computer, a desktop, or a personal digital assistant. The infotainment unit may be a unit associated with an entity. In one embodiment, the entity may encompass the system. The entity may be a vehicle. The vehicle may be a car, a truck, a commercial vehicle, a passenger vehicle, a load vehicle, etc. The vehicle may also be one of an autonomous vehicle, a non-autonomous vehicle, and a semi-autonomous vehicle. The vehicle may be an electric vehicle, hybrid vehicle, internal combustion engine vehicle, etc.

The display 102 may be one of a micro-LED display, an organic light-emitting diode (OLED) display, a light-emitting diode (LED) display, a direct-lit light-emitting diode display, a full-array light-emitting diode display, a mini-LED display, and a quantum dot light-emitting diode display. In an embodiment, the display 102 comprises an active matrix backlight. The active matrix backlight is adapted to activate pixels-by-pixels or small portions of the display. In an embodiment, the system uses the micro-LED display to depict the one or more contents and contexts. The micro-LED display comprises a plurality of pixels. A pixel of the plurality of pixels comprises an array of microscopic LEDs. In an embodiment, the micro-LED display is configured to control light at pixel-level.

The system may comprise a sensor module that determines one or more interior features and one or more exterior features of an entity. In an embodiment, the one or more interior features comprises a position of one or more seats within a vehicle and a position of one or more occupants within the vehicle. In an embodiment, the one or more exterior features comprises an ambient lighting condition around a vehicle, a scene around the vehicle, a parking location of the vehicle, and a mobility information of the vehicle. In an embodiment, the sensor module is configured to determine position of one or more occupants and a movement of a vehicle. The artificial intelligence engine 106 is configured to determine operating mode of the entity based on the one or more interior features and the one or more exterior features. In an embodiment, the operating mode comprises one of a standby mode, a parking mode, a driving mode, and a campfire mode.

The artificial intelligence engine 106 determines an operating mode of the entity (e.g., vehicle) based on the one or more interior features and the one or more exterior features. For example, the sensor module determines that the four occupants in the vehicle facing each other as the interior features. The sensor module determines the static nature of the vehicle for a predefined time period as exterior feature. The sensor module may also confirm that the vehicle is static by correlating with Global Positioning System (GPS). The artificial intelligence engine 106 then determines that the vehicle is in campfire mode. The sensor module may comprise a camera in addition to other sensors to determine the one or more interior features and the one or more exterior features.

In another example, the sensor module determines the interior feature as two occupants in a front row of the vehicle. The sensor module also determines the mobility of the vehicle as an exterior feature. The sensor module may also confirm that the vehicle is moving by correlating with Global Positioning System (GPS). The artificial intelligence engine 106 then determines that the vehicle is in driving mode. The sensor module may comprise a camera in addition to other sensors to determine the one or more interior features and the one or more exterior features. In another example, the sensor module determines the interior feature as two occupants. The sensor module also determines the static nature of the vehicle for a predefined time period and parking scene as exterior features. The sensor module may also confirm that the vehicle is static by correlating with Global Positioning System (GPS). The artificial intelligence engine 106 then determines that the vehicle is in parking mode. The sensor module may comprise a camera in addition to other sensors to determine the one or more interior features and the one or more exterior features.

In an embodiment, the system comprises a display alignment and orientation module. The display alignment and orientation module aligns and orients the display based on a user input. In one embodiment, the display alignment and orientation module automatically aligns, and orients the display with respect to the position of the one or more occupants and activates one or more portions of the display based on an operating mode of the vehicle. In an embodiment, the display alignment and orientation module comprises a motor, a first linear guide rail, a second linear guide rail, and a gear mechanism. The first linear guide rail and the second linear guide rail are coupled to the motor via the gear mechanism. The first linear guide rail aligns and orients the display to a range of predefined degrees in a first direction. The second linear guide rail aligns and orients the display to a range of predefined degrees in a second direction. The display alignment and orientation module is adapted to receive the command from the processor and automatically align and orient the display to a predefined position and angle. In an embodiment, the display alignment and orientation module is adapted to turn around in between the first row seat and second row seat of the entity (e.g., vehicle). In one embodiment, the entity may comprise an extended display or an additional display that is located between the first row seat and second row seat of the entity (e.g., vehicle). The display control module may communicate the command to the respective display to display the one or more contents.

The display may be associated with (e.g., integrated) a supporting structure. In an embodiment, the display is transparent and overlaid onto the supporting structure such that the one or more contents are displayed onto the supporting structure. The supporting structure may be a wood, a plastic, a polycarbonate sheet, a dashboard, a metal, a material coated with fabric, a screen, etc. The supporting structure is adapted to hold the display and provide support. The supporting structure is further adapted to depict the contents projected by the display. The display may be a transparent screen overlaid onto the supporting structure.

In one embodiment, the display control module is configured to perform seamless transition of the one or more contents between the display and the supporting structure. In another embodiment, the display control module is configured to display the one or more contents onto a display of the dashboard. In an embodiment, the contents displayed onto the display of the dashboard of the vehicle may be viewed from both inside and outside of the vehicle.

In another embodiment, the processor receives a trigger signal from a hardware component and communicates the command to the display control module. The trigger signal comprises a signal triggered due to one of turning the display, user interaction portions of the display, position of a steering wheel, spatial orientation of supporting structure and the display, a parking signal, and an operating mode. For example, the position of the steering wheel may trigger a signal to the processor to display the wheel angle of the vehicle in real-time. In another example, the turning of the display between the first row seat and the second row seat may trigger a signal to the processor to display contents related to infotainment. In another example, the parking signal may trigger a signal to the processor to display contents related to infotainment or work.

In an embodiment, the processor communicates the command to the display control module based on the trigger signal. The trigger signal may be received by the processor based on vehicle's interior features. In an embodiment, the contents and features displayed are divided into packages based on the position (folding position or rotation) of the seats and interior rotation (drive/campfire). Consequently, for each interior position, the processor handles a smaller set of processes to determine what to display based on the interior features.

In another embodiment, the process performs different functions based on the mobility of the vehicle (moving or static). The processor determines the exterior features using the sensor module. When the processor determines that the vehicle is moving, the processor communicates the command to reduce real estate of the display and direct the saved energy towards drivetrain and Advanced Driver Assistance System (ADAS). The processor also instructs the electronic control unit, the vehicle computer system, and the display control module to reduce entertainment features and to be driver focused to use less energy.

The processor also communicates the command to the display control module based on the determination of user interactions. The display control module instructs the display to dim down after 30-40 seconds of user inactivity, afterwards, the driver menu minimizes. The processor determines and monitors the user interactions via the sensor module. The processor scales down and repositions the display of the contents when the interaction is completed (e.g. after setting the destination, the navigation morphs from map to turn-by-turn moving on the Digital Interactive Maps (DIM), automatically closing the navigation menu).

In one embodiment, the display is configured to activate as few pixels as possible while providing more clues for glanceability (uses line art and few 3D elements). In another embodiment, the processor, based on the analysis of the contents, communicates a command to the display control module to activate as few pixels as possible. The display having user interface is designed utilizing colors that consumes the least amount of energy when displayed using micro-LED technology (spectrum of blue-green). The display control module is configured to display the content once, where needed, avoiding data duplication.

In an embodiment, the artificial intelligence engine comprises a natural language processing (NLP) engine. The artificial intelligence engine analyzes the one or more contents and extracts one or more key information based on at least one of tokenization, part-of-speech (POS) tagging, named entity recognition (NER), dependency parsing, sentiment analysis, and text classification. The natural language processing (NLP) engine determines the one or more relevant portions and the one or more redundant portions based on trained datasets of extraction of the one or more key information. In another embodiment, the artificial intelligence engine analyzes the one or more contents, detects one or more objects from the one or more contents, classifies the one or more objects, and determines the one or more relevant portions and the one or more redundant portions based on trained datasets of classification of the one or more objects.

For example, the one or more relevant portions comprises an attendee image in a video call screen and the one or more redundant portions comprises a background image in the video call screen. The one or more relevant portions comprises meaningful information that depicts at least one of an alert, a message, information, a warning, a user interaction menu, a visual element, an image, an attachment, an audio, and a playback file. In an embodiment, removal of one or more redundant portions does not impact essential content of the one or more contents. In another embodiment, removal of one or more relevant portions impacts the essential content of the one or more contents.

The display control module 104, upon receipt of the command from the processor, controls the one or more first pixels and the one or more second pixels to display the one or more contents with optimized energy consumption. In an embodiment, the display control module 104 turns on only the necessary pixels (i.e., the one or more second pixels) to display the one or more contents with optimized energy consumption. As the display control module 104 lights up the one or more second pixels, the relevant contents are displayed to the occupants/users. As the display control module 104 turns off only the first pixels (i.e. the redundant portions), the essential contents are displayed without fail and do not impact the meaning of the one or more contents. For example, in case of having a video call screen as the content, the display control module 104 turns off the pixels of redundant portions (i.e., background image) and turns on only pixels of relevant portion (i.e. the image of one or more attendees). For example, in case of having a user interaction menu as the content, the display control module 104 turns off the redundant portions (i.e., background image, empty screen, etc.) and turns on only the relevant portions (i.e. menu, user interactive tabs, notification, alerts, message, etc.). The display control module 104 achieves optimized energy consumption by turning off the pixels that correspond to the redundant portions of the contents.

In another embodiment, the display control module 104 reduces the luminance level or brightness level of the one or more redundant portions, then the luminance level or brightness level of the one or more relevant portions. For example, in case of having a video call screen as the content, the display control module 104 reduces the brightness level of redundant portions (i.e., background image) more than the brightness level of relevant portions (i.e. the image of one or more attendees). The display control module 104 achieves optimized energy consumption by reducing the brightness levels to the pixels that correspond to the redundant portions of the contents. The voltage supplied to the redundant portions is significantly less when compared to the voltage supplied to the relevant portions, thus achieving optimized energy consumption.

In one embodiment, the processor via the sensor module determines that the certain visual element in the display is not interacted for a predefined time period. The sensor module comprising a camera may determine that the certain visual element in the display is not interacting for a predefined time period. In one embodiment, the sensor module comprising a touch screen sensor may determine that that the certain visual element in the display is not interacted for a predefined time period. The processor based on the determination communicates the command to the display control module to turn off the redundant pixels (e.g., the pixels that are not interacted for a predefined time period).

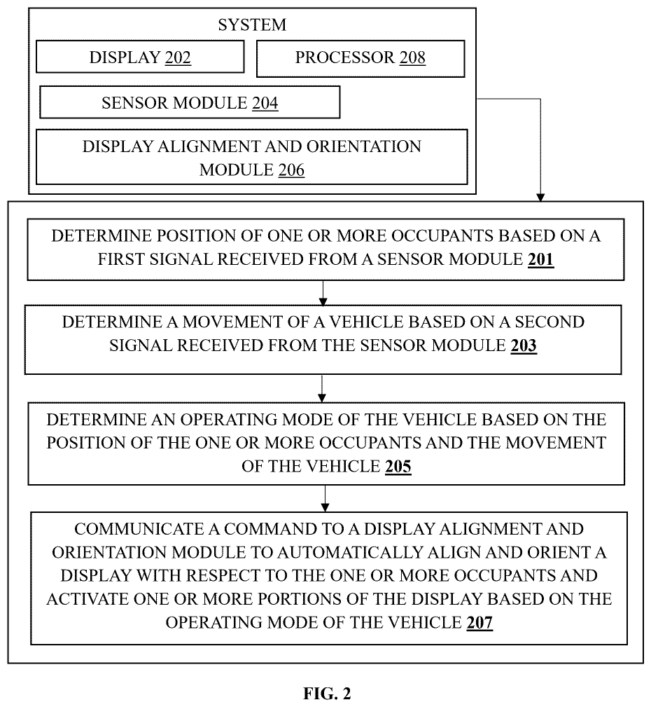

In another aspect, a system is described. As an example, FIG. 2 illustrates a system that aligns, and orients the display for optimized energy consumption, according to one or more embodiments. The system comprises: a display 202; a sensor module 204; a display alignment and orientation module 206; and a processor 208. The processor 208 stores instructions that, when executed, causes the processor 208 to execute the technical steps as follows. The processor 208 determines position of one or more occupants based on a first signal received from the sensor module (at step 201). The processor 208 determines a movement of a vehicle based on a second signal received from the sensor module 204 (at step 203). The processor 208 determines an operating mode of the vehicle based on the position of the one or more occupants and the movement of the vehicle (at step 205). The processor 208 then communicates a command to the display alignment and orientation module to automatically align and orient the display 202 with respect to the one or more occupants and activates one or more portions of the display 202 based on the operating mode of the vehicle (at step 207).

In an embodiment, the display alignment and orientation module 206 displays one or more contents onto the display (e.g., dashboard, seatback displays, head-up displays, rear entertainment display, etc.) of the vehicle based on the command. The display alignment and orientation module 206 aligns and orients the display 202 of the vehicle. The sensor module 204 determines an ambient lighting around the entity (e.g., vehicle). In an embodiment, the display alignment and orientation module 206 aligns and orients the display 202 with respect to the one or more occupants and activates one or more portions of the display 202 based on the ambient lighting determination by the sensor module 204.

In an embodiment, the display alignment and orientation module 206 aligns and orients the display 202 based on a user input received from a user. In an embodiment, the user input may comprise at least one of an operating mode, a number of occupants, a seating positions, etc. In another embodiment, the sensor module 204 determines one or more interior features and one or more exterior features. The display alignment and orientation module 206 aligns and orients the display 202 based on at least one of the one or more interior features and the one or more exterior features. In an embodiment, the display alignment and orientation module 206 aligns and orients the display 202 in between the front seat row and the back seat row when the sensor module determines that the seats are turned around and the occupants in the front row and back seat face each other. In an embodiment, the display alignment and orientation module 206 aligns and orients the display 202 with respect to the driver when the sensor module determines that there is only one occupant in the driver seat. In an embodiment, the display alignment and orientation module 206 aligns and orients the display 202 with respect to the front seat row when the sensor module determines that there are only occupants in the front seat row. In an embodiment, the display alignment and orientation module 206 aligns and orients the display 202 in response to ambient lighting condition. For example, when the sensor module determines that there is sunlight falling inside the vehicle, the display alignment and orientation module 206 aligns, tilts, and orients the display 202 such that there is no glare to the occupants.

In an embodiment, the system comprises a display control module. In an embodiment, the display control module controls and illuminates one or more first pixels and one or more second pixels of the display based on determination of one or more redundant portions and one or more relevant portions of one or more contents (as described above in FIG. 1). In an embodiment, the display control module illuminates one or more first portions of the display based on one or more contexts of one or more contents and displays the one or more contents onto the one or more first portions.

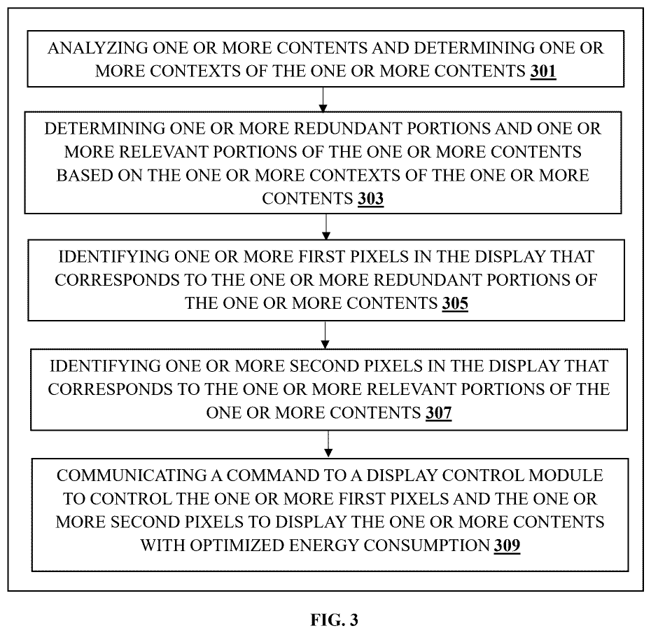

In another aspect, a method is described. As an example, FIG. 3 illustrates a method of analyzing one or more contents and turning on only necessary pixels for optimized energy consumption, according to one or more embodiments. The method comprises the technical steps as follows: analyzing one or more contents and determining one or more contexts of the one or more contents (at step 301); determining one or more redundant portions and one or more relevant portions of the one or more contents based on the one or more contexts of the one or more contents (at step 303); identifying one or more first pixels in the display that correspond to the one or more redundant portions of the one or more contents (at step 305); identifying one or more second pixels in the display that corresponds to the one or more relevant portions of the one or more contents (at step 307); and communicating a command to a display control module to control the one or more first pixels and the one or more second pixels to display the one or more contents with optimized energy consumption (at step 309). In an embodiment, the method further comprises: aligning and orienting the display based on a user input received from a user. In an embodiment, the user input may comprise at least one of an operating mode, a number of occupants, a seating positions, etc. In an embodiment, the method further comprises: automatically aligning, and orienting the display with respect to position of one or more occupants and activating one or more portions of the display based on an operating mode of a vehicle. The method further comprises: illuminating one or more first portions of the display based on the one or more contexts of the one or more contents and displaying the one or more contents onto the one or more first portions.

In another aspect, a method is described. As an example, FIG. 4 illustrates a method of aligning and orienting the display for optimized energy consumption, according to one or more embodiments. The method comprises the technical steps as follows: determining position of one or more occupants based on a first signal received from a sensor module (at step 401); determining a movement of a vehicle based on a second signal received from the sensor module (at step 403); determining an operating mode of the vehicle based on the position of the one or more occupants and the movement of the vehicle (at step 405); and communicating a command to a display alignment and orientation module to automatically align and orient a display with respect to the one or more occupants and activate one or more portions of the display based on the operating mode of the vehicle (at step 407). The method further comprises: displaying one or more contents onto one or more display of the vehicle based on the command. In an embodiment, the method further comprises: aligning and orienting the display based on a user input. In an embodiment, the user input may comprise at least one of an operating mode, a number of occupants, a seating positions, etc. In an embodiment, the method further comprises: aligning and orienting the display with respect to the one or more occupants and activate one or more portions of the display based on ambient lighting.

In an embodiment, the method further comprises: controlling and illuminating one or more first pixels and one or more second pixels of the display based on determination of one or more redundant portions and one or more relevant portions of one or more contents. In another embodiment, the method further comprises: illuminating one or more first portions of the display based on one or more contexts of one or more contents and displays the one or more contents onto the one or more first portions.

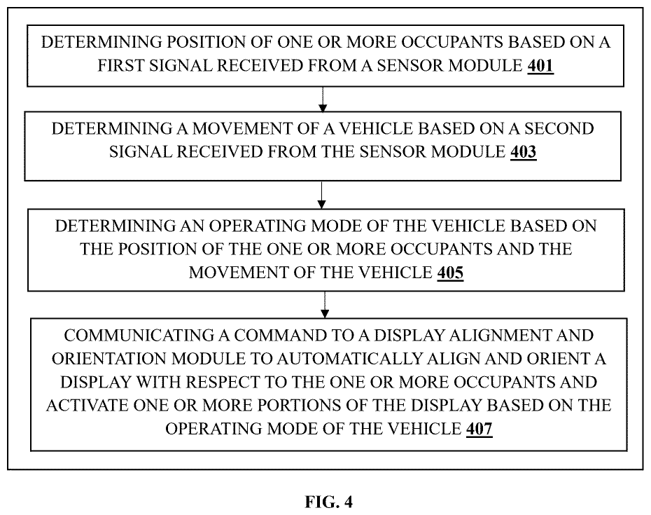

In another aspect, a non-transitory computer readable medium is described. As an example, FIG. 5 illustrates a non-transitory computer readable medium, according to one or more embodiments. The non-transitory computer readable medium storing a sequence of instructions, which when executed by a processor causes: analyzing one or more contents and determining one or more contexts of the one or more contents (at step 501); determining one or more redundant portions and one or more relevant portions of the one or more contents based on the one or more contexts of the one or more contents (at step 503); identifying one or more first pixels in the display that correspond to the one or more redundant portions of the one or more contents (at step 505); identifying one or more second pixels in the display that corresponds to the one or more relevant portions of the one or more contents (at step 507); and communicating a command to a display control module to control the one or more first pixels and the one or more second pixels to display the one or more contents with optimized energy consumption (at step 509). In an embodiment, the non-transitory computer readable medium further causes: aligning and orienting the display based on a user input. The user input comprise at least one of an operating mode, a number of occupants, a seating positions, etc. In an embodiment, the non-transitory computer readable medium further causes: automatically aligning, and orienting the display with respect to position of one or more occupants and activating one or more portions of the display based on an operating mode of a vehicle. In one embodiment, the non-transitory computer readable medium further causes: illuminating one or more first portions of the display based on the one or more contexts of one or more contents and displays the one or more contents onto the one or more first portions.

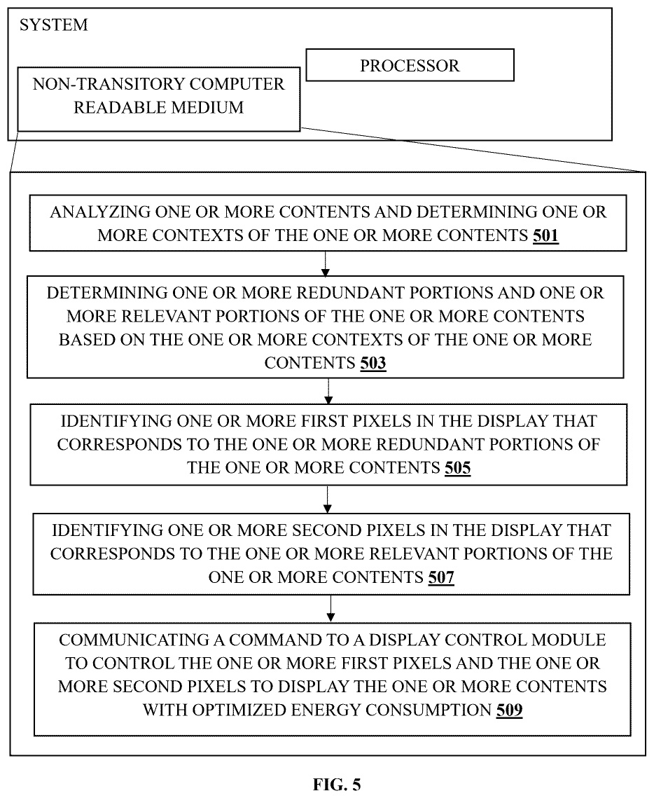

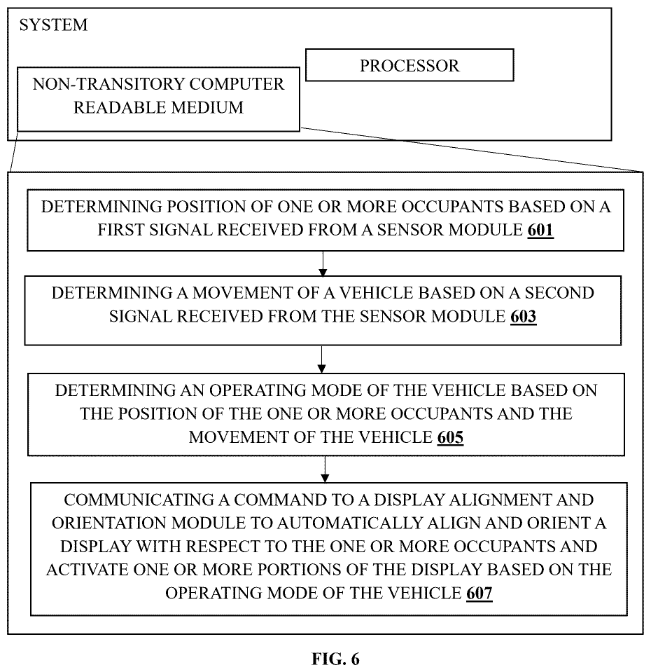

In another aspect, a non-transitory computer readable medium is described. As an example, FIG. 6 illustrates a non-transitory computer readable medium, according to one or more embodiments. The non-transitory computer readable medium storing a sequence of instructions, which when executed by a processor causes: determining position of one or more occupants based on a first signal received from a sensor module (at step 601); determining a movement of a vehicle based on a second signal received from the sensor module (at step 603); determining an operating mode of the vehicle based on the position of the one or more occupants and the movement of the vehicle (at step 605); and communicating a command to a display alignment and orientation module to automatically align and orient a display with respect to the one or more occupants and activate one or more portions of the display based on the operating mode of the vehicle (at step 607). The non-transitory computer readable medium further causes: displaying one or more contents onto the display of the vehicle based on the command.

In an embodiment, the non-transitory computer readable medium further causes: aligning and orienting the display based on a user input. The user input comprise at least one of an operating mode, a number of occupants, a seating positions, etc. In another embodiment, the non-transitory computer readable medium further causes: aligning and orienting the display with respect to the one or more occupants and activates one or more portions of the display based on ambient lighting.

In an embodiment, the non-transitory computer readable medium further causes: controlling and illuminating one or more first pixels and one or more second pixels of the display based on determination of one or more redundant portions and one or more relevant portions of one or more contents. In another embodiment, the non-transitory computer readable medium further causes: illuminating one or more first portions of the display based on one or more contexts of one or more contents and displays the one or more contents onto the one or more first portions.

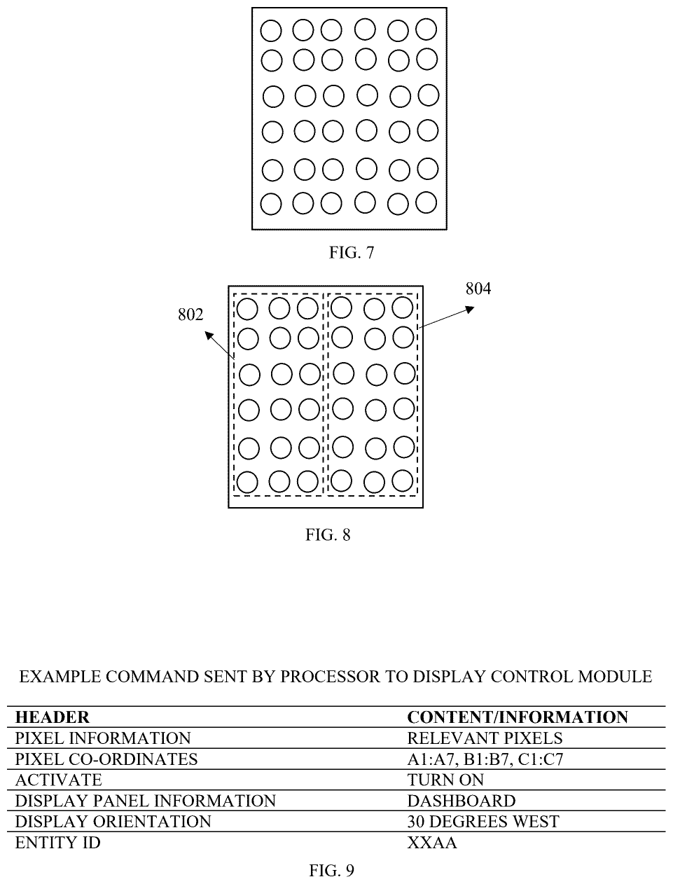

As an example, FIG. 7 illustrates a schematic diagram of a micro-LED display, according to one or more embodiments. The micro-LED display comprises a plurality of pixels. Each pixel comprises an array of microscopic LEDs. The plurality of pixels is configured to depict the one or more contents. The one or more contents may comprise one or more relevant portions and one or more redundant portions (as shown in FIG. 8).

As an example, FIG. 8 illustrates a schematic diagram of a micro-LED display depicting one or more relevant pixels and one or more redundant pixels, according to one or more embodiments. The one or more contents may comprise one or more redundant portions 802 and one or more relevant portions 804. The processor analyzes the one or more contents and extracts one or more key information. The processor extracts the one or more key information based on at least one of tokenization, part-of-speech (POS) tagging, named entity recognition (NER), dependency parsing, sentiment analysis, and text classification. The processor alone is capable of analyzing the contents and determining the one or more relevant portions 804 and the one or more redundant portions 802.

In one embodiment, the processor may comprise an artificial intelligence engine. The natural language processing (NLP) engine determines the one or more relevant portions 804 and the one or more redundant portions 802 based on trained datasets of extraction of the one or more key information. For example, in case of a user interaction menu, the artificial intelligence engine analyzes the one or more contents of the user interaction menu and parses the one or more contents into the one or more relevant portions 804 and the one or more redundant portions 802 based on the one or more key information. The artificial intelligence engine identifies the one or more first pixels that correspond to the one or more redundant portions 802. The artificial intelligence engine identifies the one or more second pixels that correspond to the one or more relevant portions 804. For example, in case of an image, the artificial intelligence engine analyzes the one or more contents, detects one or more objects from the one or more contents, classifies the one or more objects, and determines the one or more relevant portions 804 and the one or more redundant portions 802 based on trained datasets of classification of the one or more objects.

In an embodiment the artificial intelligence engine comprises at least one of an object detection engine, a semantic segmentation engine, an image classification engine, an instance segmentation engine, an object recognition and localization engine, and an image captioning engine.

As an example, FIG. 9 illustrates a command communicated to a display control module, according to one or more embodiments. The processor generates a command based on analysis of the one or more contents. The command comprises fields such as pixel information, pixel coordinates, activate, display panel information, and display orientation. The pixel information may comprise co-information such as relevant pixels. The pixel coordinates field may comprise coordinates information such as A1: A7, B1: B7, C1: C7. The activate field may comprise information regarding which pixels are to be activated. For example, the activate field may comprise information as “TURN ON”. In another example, the activate field may comprise information as “MEDIUM BRIGHTNESS” which is oriented towards the pixels mentioned in the pixel information field (e.g., relevant pixels). The display panel information may comprise information regarding which display panel is to be activated. For example, the display panel information may comprise information as dashboard panel to be activated. The display orientation may comprise information regarding an angle on which the display is to be oriented for better visibility. For example, the display orientation may comprise information as 30 degrees towards west. The display oriented 30 degrees towards the west direction may provide better visibility to the driver.

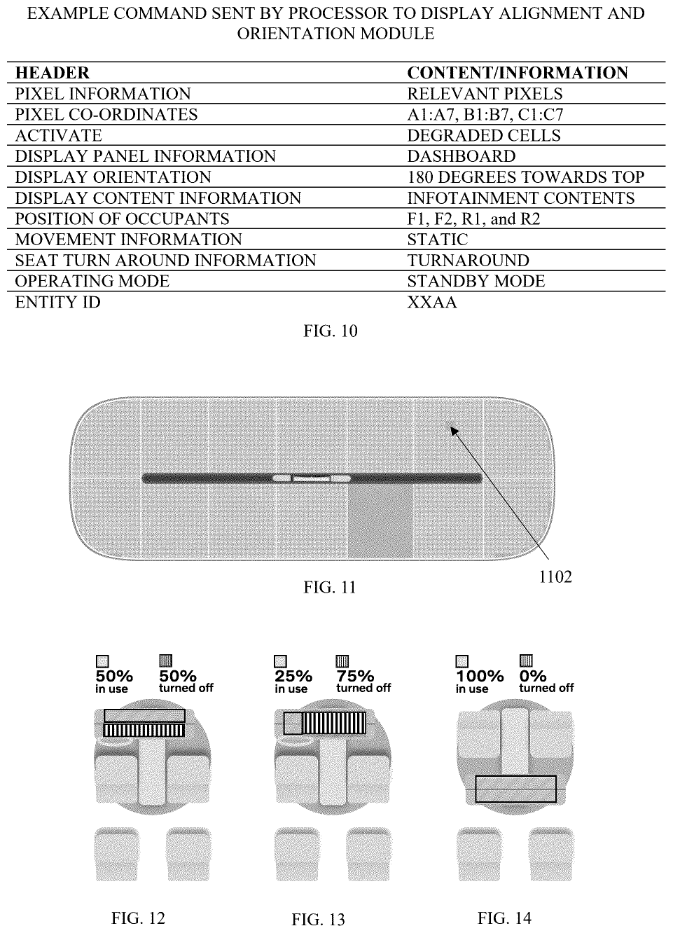

As an example, FIG. 10 illustrates a command communicated to a display alignment and orientation module, according to one or more embodiments. The processor generates a command based on the operating mode of the vehicle. The command comprises fields such as position of occupants, movement information, pixel information, pixel coordinates, activate, display panel information, seat turn around information, operating mode, display orientation, and display content information. The position of occupants field comprises information as F1, F2, R1, and R2. F1 refers to occupant at first seat of front row. F2 refers to occupant at second seat of front row. R1 refers to occupant at first seat of rear row. R2 refers to occupant at second seat of rear row. The movement information may comprise information as static. The pixel information may comprise co-information such as relevant pixels. The pixel coordinates field may comprise coordinates information such as Al: A7, B1: B7, C1: C7. The activate field may comprise information regarding which pixels are to be activated. For example, the activate field may comprise information as “TURN ON”. In another example, the activate field may comprise information as “MEDIUM BRIGHTNESS”. The display panel information may comprise information regarding which display panel is to be activated. For example, the display panel information may comprise information as dashboard panel to be activated. The operating mode field may comprise information as standby mode. The display orientation may comprise information regarding an angle on which the display is to be oriented for better visibility. For example, the display orientation may comprise information as 180 degrees facing towards top. The display oriented 180 degrees perpendicular facing towards top may provide better visibility to all occupants. The display content information field may comprise information as infotainment (e.g., video game, movie, etc.). The seat turn around information field may comprise information related to turnaround information of front seat. In one embodiment, the seat turnaround information field may comprise information as “TURNAROUND” OR “NORMAL”.

As an example, FIG. 11 illustrates a display control module turning off a single pixel of a display, according to one or more embodiments. The processor analyzes the contents to be displayed. The processor parses the contents and identifies the relevant portions and the redundant portions based on the key information. The processor then identifies the one or more first pixels that corresponds to the redundant portions. The processor then identifies the one or more second pixels that corresponds to the relevant portions. The processor then communicates a command to the display control module to turn off the first pixels that corresponds to the redundant portions.

The redundant portions may encompass a single pixel or a plurality of pixels. The plurality of pixels corresponding to the redundant portions may encompass pixels in an order (e.g., sequential order, any shape like a box, circle, an image, etc.) or a random fashion (i.e., distributed in between the relevant pixels). Similarly, the relevant portions may encompass a single pixel or a plurality of pixels. The plurality of pixels corresponding to the relevant portions may encompass pixels in an order (e.g., sequential order, contiguous, may be of any shape like a box, circle, an image, etc.) or a random fashion (i.e., distributed in between the redundant pixels, non-contiguous, etc.). In this case, the processor identifies a single pixel 1102 as a redundant pixel and turns off the single pixel 1102 as shown in FIG. 11.

As an example, FIG. 12 illustrates a display in a waiting mode, according to one or more embodiments. The waiting mode may be a standby mode. The processor determines an operating mode of the vehicle based on one or more interior features and one or more exterior features. The processor determines the operating mode as standby mode when the vehicle is static and with no occupant. The occupants are outside the vehicle viewing the contents on the display. In one example, the processor may determine the operating mode as parking mode when the vehicle is static and with no occupant. In this example, the processor determines that there are two occupants in the front row seat and the vehicle is static for a predefined time period. The processor determines that the vehicle is in specific standby mode. The processor using the artificial intelligence engine then determines/suggests the contents to be displayed based on the operating mode. In an embodiment, the processor may select the content based on the operating mode.

The processor then analyzes the contents to be displayed. The processor parses the contents and identifies the relevant portions and the redundant portions based on the key information. The processor then identifies the one or more first pixels that corresponds to the redundant portions. The processor then identifies the one or more second pixels that corresponds to the relevant portions. The processor then communicates a command to the display control module to turn off the first pixels that correspond to the redundant portions. In this example, the processor communicates the command to the display control module to turn off the redundant pixels on the bottom portion.

As an example, FIG. 13 illustrates a display in a driving mode, according to one or more embodiments. The processor determines an operating mode of the vehicle based on one or more interior features and one or more exterior features. The processor determines the operating mode as driving mode when the vehicle is moving and has at least one occupant (e.g., driver). In this example, the processor determines that there is one occupant (e.g., driver) in the front row seat and the vehicle is moving. The processor determines that the vehicle is in driving mode. The processor using the artificial intelligence engine then determines the contents to be displayed based on the operating mode. In an embodiment, the processor may select the content based on the operating mode.

The processor then analyzes the contents to be displayed. The processor parses the contents and identifies the relevant portions and the redundant portions based on the key information. The processor then identifies the one or more first pixels that corresponds to the redundant portions. The processor then identifies the one or more second pixels that corresponds to the relevant portions. The processor then communicates a command to the display control module to turn off the first pixels that correspond to the redundant portions. In this example, the processor communicates the command to the display control module to turn on only the pixels that are sufficient and closer to the driver and turns off the pixels that are farther from the driver.

As an example, FIG. 14 illustrates a display in a campfire mode, according to one or more embodiments. The processor determines an operating mode of the vehicle based on one or more interior features and one or more exterior features. The processor determines the operating mode as campfire mode when the vehicle is static for a predefined time period and with one or more occupants with front row and back row facing each other. In this example, the processor determines that there is at least one occupant in the front row seat and back row seat and the vehicle is static. The processor determines that the vehicle is in campfire mode. The processor using the artificial intelligence engine then determines the contents to be displayed based on the operating mode. In an embodiment, the processor may select the content based on the operating mode. The display may be aligned and oriented between the front row and the back row as shown in FIG. 14.

The processor then analyzes the contents to be displayed. The processor parses the contents and identifies the relevant portions and the redundant portions based on the key information. The processor then identifies the one or more first pixels that corresponds to the redundant portions. The processor then identifies the one or more second pixels that corresponds to the relevant portions. The processor then communicates a command to the display control module to turn off the first pixels that correspond to the redundant portions.

In an embodiment, the system further comprises a cyber security module wherein the cyber security module comprises an information security management module providing isolation between the communication module and servers.

In an embodiment, the information security management module is operable to, receive data from the communication module, exchange a security key at a start of the communication between the communication module and the server, receive the security key from the server, authenticate an identity of the server by verifying the security key, analyze the security key for a potential cyber security threat, negotiate an encryption key between the communication module and the server, encrypt the data; and transmit the encrypted data to the server when no cyber security threat is detected.

In an embodiment, the information security management module is operable to exchange a security key at a start of the communication between the communication module and the server, receive the security key from the server, authenticate an identity of the server by verifying the security key, analyze the security key for a potential cyber security threat, negotiate an encryption key between the system and the server, receive encrypted data from the server, decrypt the encrypted data, perform an integrity check of the decrypted data and transmit the decrypted data to the communication module when no cyber security threat is detected.

In one aspect, a secure communication management (SCM) computer device for providing secure data connections is provided. The SCM computer device includes a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment and transmit the converted first data message to the vehicle system using a first communication protocol associated with the vehicle system.

According to an embodiment, secure authentication for data transmissions comprises, provisioning a hardware-based security engine (HSE) located in communications system, said HSE having been manufactured in a secure environment and certified in said secure environment as part of an approved network; performing asynchronous authentication, validation and encryption of data using said HSE, storing user permissions data and connection status data in an access control list used to define allowable data communications paths of said approved network, enabling communications of the communications system with other computing system subjects to said access control list, performing asynchronous validation and encryption of data using security engine including identifying a user device (UD) that incorporates credentials embodied in hardware using a hardware-based module provisioned with one or more security aspects for securing the system, wherein security aspects comprising said hardware-based module communicating with a user of said user device and said HSE.

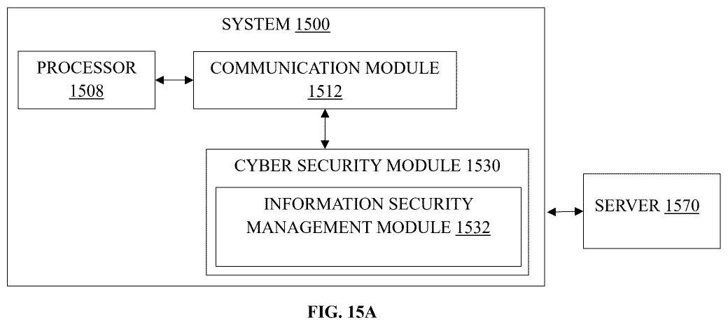

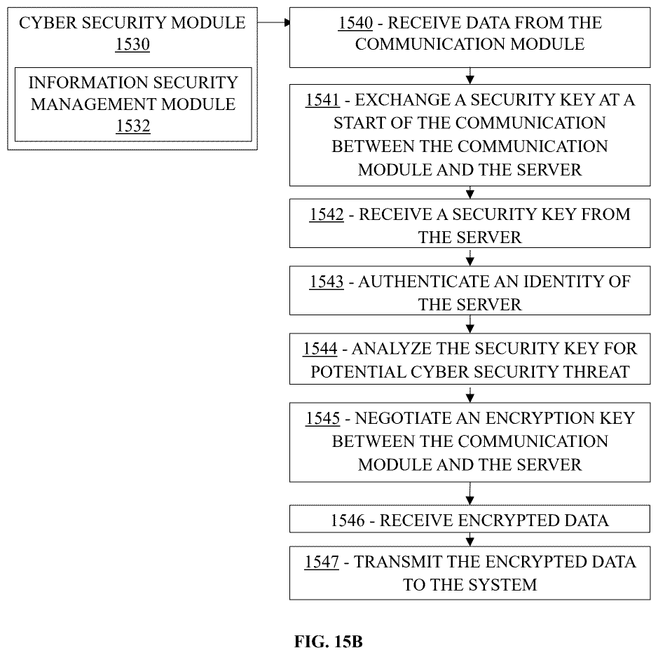

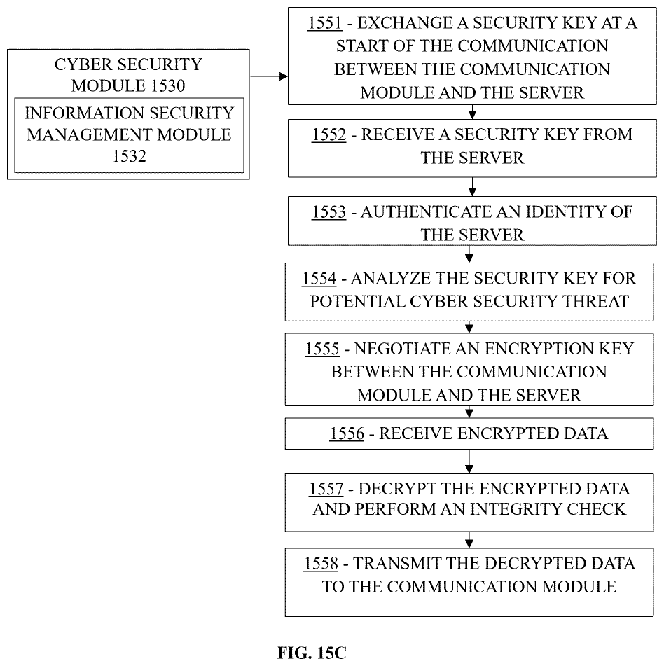

In an embodiment, FIG. 15A shows the block diagram of the cyber security module. The communication of data between the system 1500 and the server 1570 through the communication module 1512 is first verified by the information security management module 1532 before being transmitted from the system to the server or from the server to the system. The information security management module is operable to analyze the data for potential cyber security threats, to encrypt the data when no cyber security threat is detected, and to transmit the data encrypted to the system or the server.

In an embodiment, the cyber security module further comprises an information security management module providing isolation between the system and the server. FIG. 15B shows the flowchart of securing the data through the cyber security module 1530. At step 1540, the information security management module is operable to receive data from the communication module. At step 1541, the information security management module exchanges a security key at a start of the communication between the communication module and the server. At step 1542, the information security management module receives a security key from the server. At step 1543, the information security management module authenticates an identity of the server by verifying the security key. At step 1544, the information security management module analyzes the security key for potential cyber security threats. At step 1545, the information security management module negotiates an encryption key between the communication module and the server. At step 1546, the information security management module receives the encrypted data. At step 1547, the information security management module transmits the encrypted data to the server when no cyber security threat is detected.

In an embodiment, FIG. 15C shows the flowchart of securing the data through the cyber security module 1530. At step 1551, the information security management module is operable to: exchange a security key at a start of the communication between the communication module and the server. At step 1552, the information security management module receives a security key from the server. At step 1553, the information security management module authenticates an identity of the server by verifying the security key. At step 1554, the information security management module analyzes the security key for potential cyber security threats. At step 1555, the information security management module negotiates an encryption key between the communication module and the server. At step 1556, the information security management module receives encrypted data. At step 1557, the information security management module decrypts the encrypted data, and performs an integrity check of the decrypted data. At step 1558, the information security management module transmits the decrypted data to the communication module when no cyber security threat is detected.

In an embodiment, the integrity check is a hash-signature verification using a Secure Hash Algorithm 256 (SHA256) or a similar method.

In an embodiment, the information security management module is configured to perform asynchronous authentication and validation of the communication between the communication module and the server.

In an embodiment, the information security management module is configured to raise an alarm if a cyber security threat is detected. In an embodiment, the information security management module is configured to discard the encrypted data received if the integrity check of the encrypted data fails.

In an embodiment, the information security management module is configured to check the integrity of the decrypted data by checking accuracy, consistency, and any possible data loss during the communication through the communication module.

In an embodiment, the server is physically isolated from the system through the information security management module. When the system communicates with the server as shown in FIG. 15A, identity authentication is first carried out on the system and the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carry out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is carried out on the data after decryption, and if verification is passed, the data is sent out through the communication module; otherwise, the data is discarded.

In an embodiment, the identity authentication is realized by adopting an asymmetric key with a signature.

In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine.

In an embodiment, both communication parties need to authenticate their own identities through a pair of asymmetric keys, and a task in charge of communication with the information security management module of the system is identified by a unique pair of asymmetric keys.

In an embodiment, the dynamic negotiation key is encrypted by adopting an Rivest-Shamir-Adleman (RSA) encryption algorithm. RSA is a public-key cryptosystem that is widely used for secure data transmission. The negotiated keys include a data encryption key and a data integrity check key.

In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model.

The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and can ensure that the safety of the data on the server cannot be compromised by a hacker attack under the condition of the Internet by ensuring the safety and reliability of the communication between the system and the server.

In an embodiment of the system, the machine learning model is configured to learn using labelled data using a supervised learning method, wherein the supervised learning method comprises logic using at least one of a decision tree, a logistic regression, a support vector machine, a k-nearest neighbors, a Naïve Bayes, a random forest, a linear regression, a polynomial regression, and a support vector machine for regression.

In an embodiment of the system, the machine learning model is configured to learn from the real-time data using an unsupervised learning method, wherein the unsupervised learning method comprises logic using at least one of a k-means clustering, a hierarchical clustering, a hidden Markov model, and an apriori algorithm.

In an embodiment of the system, the machine learning model has a feedback loop, wherein the output from a precious step is fed back to the model in real-time to improve the performance and accuracy of the output of a next step.

In an embodiment of the system, the machine learning model comprises a recurrent neural network model.

In an embodiment of the system, the machine learning model has a feedback loop, wherein the learning is further reinforced with a reward for each true positive of the output of the system.

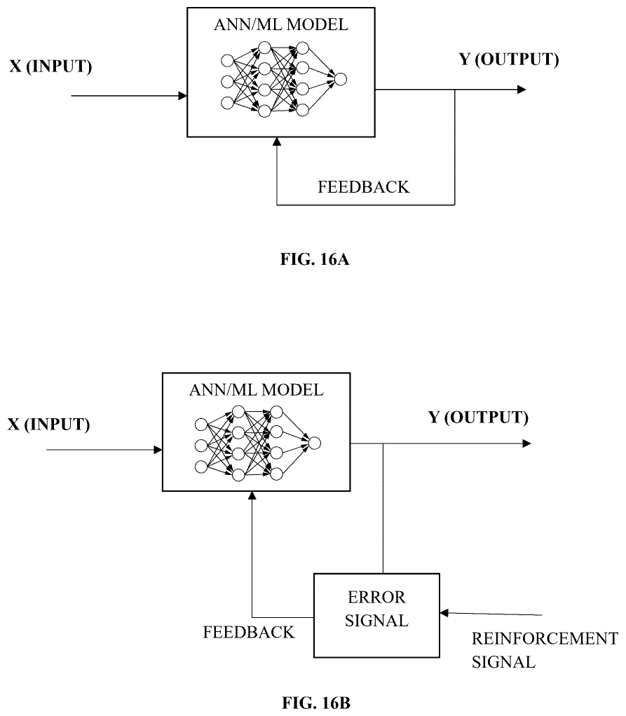

FIG. 16A shows a structure of the neural network/machine learning model with a feedback loop. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. The model may learn from the data. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an apriori algorithm. The output layer may predict or detect first pixels and second pixels based on the input data. The output layer may also determine the contents to be displayed.

In an embodiment, ANNs may be a Deep-Neural Network (DNN), which is a multilayer tandem neural network comprising Artificial Neural Networks (ANN), Convolution Neural Networks (CNN) and Recurrent Neural Networks (RNN) that can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, and image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback. The variations of weights in the hidden layer(s) will be adjusted to fit the expected outputs better while training the model. This will allow the model to provide results with far fewer mistakes.

The neural network is featured with the feedback loop to adjust the system output dynamically as it learns from the new data. In machine learning, backpropagation and feedback loops are used to train an AI model and continuously improve it upon usage. As the incoming data that the model receives increases, there are more opportunities for the model to learn from the data. The feedback loops, or backpropagation algorithms, identify inconsistencies and feed the corrected information back into the model as an input.

Even though the AI/ML model is trained well, with large sets of labelled data and concepts, after a while, the models' performance may decline while adding new, unlabelled input due to many reasons which include, but not limited to, concept drift, recall precision degradation due to drifting away from true positives, and data drift over time. A feedback loop to the model keeps the AI results accurate and ensures that the model maintains its performance and improvement, even when new unlabelled data is assimilated. A feedback loop refers to the process by which an AI model's predicted output is reused to train new versions of the model.

Initially, when the AI/ML model is trained, a few labelled samples comprising both positive and negative examples of the concepts (for e.g., contexts, contents) are used that are meant for the model to learn. Afterward, the model is tested using unlabelled data. By using, for example, deep learning and neural networks, the model can then make predictions on whether the desired concept/s (for e.g., contents to be displayed) are in unlabelled images. Each image is given a probability score where higher scores represent a higher level of confidence in the models' predictions. Where a model gives an image a high probability score, it is auto labelled with the predicted concept. However, in the cases where the model returns a low probability score, this input may be sent to a controller (may be a human moderator) which verifies and, as necessary, corrects the result. The human moderator may be used only in exception cases. The feedback loop feeds labelled data, auto-labelled or controller-verified, back to the model dynamically and is used as training data so that the system can improve its predictions in real-time and dynamically.

FIG. 16B shows a structure of the neural network/machine learning model with reinforcement learning. The network receives feedback from authorized networked environments. Though the system is similar to supervised learning, the feedback obtained in this case is evaluative not instructive, which means there is no teacher as in supervised learning. After receiving the feedback, the network performs adjustments of the weights to get better predictions in the future. Machine learning techniques, like deep learning, allow models to take labeled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

In an embodiment, icons on a graphical user interface (GUI) or display of the infotainment system of a computer system are re-arranged based on a priority score of the content of the message. The processor tracks the messages that need to be displayed at a given time and generates a priority score, wherein the priority score is determined based on the action that needs to be taken by the user, the time available before the user input is needed, content of the message to be displayed, criticality of the user's input/action that needs to be taken, the sequence of the message or messages that need to be displayed and executed, and the safety of the overall scenario. For example, in case of a health emergency, the messages in queue for displaying could be an emergency signal, type of emergency, intimation that an alert is provided to the nearby vehicles, instructing a path for the driver to pull over, calling the emergency services, etc. In all these messages that need a driver's attention, a priority score is provided based on the actions that need to be taken by the user, the time available for the user to receive the displayed message and react with an action, the content of the message, criticality of the user's input/action, sequence of the messages that need to be executed, and safety of the overall scenario. Considering the above example, the message that intimates the user/driver that an alert has been provided to nearby vehicles may be of lower priority as compared to instructing the path for the driver to pull over. Therefore, the pull over directions for the path message takes priority and takes such a place on the display (example, center of the display) which can grab the users' attention immediately. The priority of the messages are evaluated dynamically as the situation is evolving and thus the display icons, positions, and sizes of the text or icon on the display are changed in real time and dynamically. In an embodiment, more than one message is displayed and highlighted as per the situation and the user's actions. Further, while pulling over, if an unsafe scenario is found for example, a car is changing lanes which may obstruct the user's vehicle, the message dynamically changes and warns the driver about the developing scenario.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

Other specific forms may embody the present invention without departing from its spirit or characteristics. The described embodiments are in all respects illustrative and not restrictive. Therefore, the appended claims rather than the description herein indicate the scope of the invention. All variations which come within the meaning and range of equivalency of the claims are within their scope.

1-53. (canceled)

54. A system comprising:
a display;
a display control module; and
a processor storing instructions that, when executed, causes the processor to:
analyze one or more contents and determine one or more contexts of the one or more contents;
determine one or more redundant portions and one or more relevant portions of the one or more contents based on the one or more contexts of the one or more contents, wherein the processor determines the one or more relevant portions based on trained data sets of one or more key information of the one or more contents;
identify one or more first pixels in the display that correspond to the one or more redundant portions of the one or more contents;
identify one or more second pixels in the display that corresponds to the one or more relevant portions of the one or more contents; and
communicate a command to the display control module to illuminate the one or more second pixels to display the one or more contents with optimized energy consumption in response to the one or more contexts.

55. The system of claim 54, wherein the system further comprises a content receiving module that receives the one or more contents from a source.

56. The system of claim 54, wherein the system comprises a sensor module that determines one or more interior features and one or more exterior features of an entity.

57. The system of claim 56, wherein the entity comprises a vehicle.

58. The system of claim 56, wherein the one or more interior features comprises a position of one or more seats within a vehicle and a position of one or more occupants within the vehicle.

59. The system of claim 56, wherein the one or more exterior features comprises an ambient lighting condition around a vehicle, a scene around the vehicle, a parking location of the vehicle, and a mobility information of the vehicle.

60. The system of claim 54, wherein removal of one or more redundant portions does not impact essential content of the one or more contents.

61. The system of claim 54, wherein removal of one or more relevant portions impacts essential content of the one or more contents.

62. The system of claim 54, wherein the system comprising an artificial intelligence engine comprises a natural language processing (NLP) engine.

63. The system of claim 62, wherein the artificial intelligence engine analyzes the one or more contents and extracts the one or more key information based on at least one of tokenization, part-of-speech (POS) tagging, named entity recognition (NER), dependency parsing, sentiment analysis, and text classification.

64. The system of claim 63, wherein the natural language processing (NLP) engine determines the one or more redundant portions based on trained datasets of extraction of the one or more key information.

65. The system of claim 56, wherein the system further comprises a display alignment and orientation module.

66. The system of claim 65, wherein the sensor module determines position of one or more occupants and a movement of a vehicle.

67. The system of claim 66, wherein the display alignment and orientation module automatically aligns, and orients the display based on a user input.

68. The system of claim 54, wherein the processor receives a trigger signal from a hardware component and communicates the command to the display control module.

69. A method comprising:
analyzing one or more contents and determining one or more contexts of the one or more contents;
determining one or more redundant portions and one or more relevant portions of the one or more contents based on the one or more contexts of the one or more contents, wherein the one or more relevant portions are determined based on trained data sets of one or more key information of the one or more contents;
identifying one or more first pixels in a display that corresponds to the one or more redundant portions of the one or more contents;
identifying one or more second pixels in the display that corresponds to the one or more relevant portions of the one or more contents; and
communicating a command to a display control module to illuminate the one or more second pixels to display the one or more contents with optimized energy consumption in response to the one or more contexts.

70. The method of claim 69, further comprising: automatically aligning, and orienting the display based on a user input.

71. A non-transitory computer readable medium storing a sequence of instructions, which when executed by a processor causes:
analyzing one or more contents and determining one or more contexts of the one or more contents;
determining one or more redundant portions and one or more relevant portions of the one or more contents based on the one or more contexts of the one or more contents, wherein the one or more relevant portions are determined based on trained data sets of one or more key information of the one or more contents;
identifying one or more first pixels in a display that corresponds to the one or more redundant portions of the one or more contents;
identifying one or more second pixels in the display that corresponds to the one or more relevant portions of the one or more contents; and
communicating a command to a display control module to illuminate the one or more second pixels to display the one or more contents with optimized energy consumption in response to the one or more contexts.

72. The non-transitory computer readable medium of claim 71, further causes: automatically aligning, and orienting the display based on a user input.

73. The non-transitory computer readable medium of claim 71, further causes: illuminating one or more first portions of the display based on the one or more contexts of the one or more contents and displaying the one or more contents onto the one or more first portions.
